(19) United States
(12) Patent Application Publication
(10) Pub. No.: US 2006/0035147 A1
(43) Pub. Date: Feb. 16, 2006

(54) Battery

(75) Inventors: Phuong-Nghi Lam, Burbank, CA (US); Hiroyuki Yumoto, Stevenson Ranch, CA (US); David M. Skinlo, Valencia, CA (US); Taison Tan, Glendora, CA (US); David l. DeMuth, Santa Clarita, CA (US)

Correspondence Address: MARY ELIZABETH BUSH;QUALLION LLC, P.O. BOX 923127, SYLMAR, CA, 91392-3127, US

(73) Assignee: Quallion LLC, Sylmar, CA (US)

(21) Appl. No.: 10/478,920

(22) PCT Filed: Jul. 9, 2003
(86) PCT No.: PCT/US03/21343

§ 371 Date: Nov. 19, 2003

(30) Foreign Application Priority Data
Jan. 15, 2003 (WO) PCT/US03/01338

(51) Int. Cl. H01M 4/48; H01M 4/56; H01M 4/58; H01M 4/66; B05D 5/12; H01M 2/26

(52) U.S. Cl. 429/218.1; 429/225; 429/231.7; 429/221; 429/220; 429/219; 429/231.5; 429/245; 427/126.1; 427/126.3; 429/161; 429/211

(57) ABSTRACT

Disclosed is a positive electrode (30) comprising: a foil substrate (32); and a slurry coated on both faces, wherein the coating (34, 36) comprises an active material comprising particles having an average diameter of greater than 1 μm to about 100 μm. Also disclosed is an electrode assembly and battery using, and a method for making, the positive electrode. Also disclosed is a method for making a negative electrode (70) comprising the acts of: providing a foil substrate (72); and laminating lithium foil (74, 78) onto both faces, leaving a portion free of lithium. Also disclosed is a hermetically sealable electric storage battery and a manufacturing method for filling and sealing it.

### REFERENCE TO PRIOR FILED APPLICATIONS

This application is a Continuation-in-Part of copending application Serial Number PCT/US03/01338, filed Jan. 15, 2003, which claims priority to copending application Ser. No. 10/167,688, filed Jun. 12, 2002, which claims priority to provisional application Ser. No. 60/348,665, filed Jan. 15, 2002, the disclosure of each of which is incorporated herein by reference in its entirety.

### GOVERNMENT LICENSE RIGHTS

Not applicable

### FIELD

This invention relates generally to electric storage batteries and more particularly to a battery construction, and method of manufacture thereof, suitable for use in implantable medical devices.

### BACKGROUND

Rechargeable electric storage batteries are commercially available in a wide range of sizes for use in a variety of applications. As battery technology continues to improve, batteries find new applications that impose increasingly stringent specifications relating to physical size and performance. New technologies have yielded smaller and lighter weight batteries having longer storage lives and higher energy output capabilities enabling an increasing range of applications, including medical applications, where, for example, the battery can be used in a medical device that is implanted in a patient's body. Such medical devices can be used to monitor and/or treat various medical conditions. Batteries for implantable medical devices are subject to very demanding requirements, including long useful life, high power output, low self-discharge rates, compact size, high reliability over a long time period, and compatibility with the patient's internal body chemistry.

Lithium ion technology is a preferred chemistry for medical implant applications. In current lithium ion batteries, the cathodes are fabricated via pressing the cathode material onto mesh current collectors such as stainless steel and titanium to form pellets. The pellets thus formed are then alternately stacked with anodes and interleaved with separator material into the following configuration: cathode|separator|anode|separator|cathode| . . . . Because of the poor adhesion between the substrate and active material, this method of fabricating the cathode by pressing the cathode material onto a current collector makes it difficult to achieve an electrochemical cell having a high power density and diminishes the rate capability of the battery.

### SUMMARY

Disclosed is a positive electrode comprising: a positive foil substrate; and a slurry coated on both faces of said positive foil substrate, wherein the coating comprises an active material chosen from the group consisting of: Bi₂O₃, Bi₂Pb₂O₅, fluorinated carbon (CFₓ), CuCl₂, CuF₂, CuO, Cu₄O(PO₄)₂, CuS, FeS, FeS₂, MnO₂, MoO₃, Ni₃S₂, AgCl, Ag₂CrO₄, V₂O₅ and related compounds, silver vanadium oxide (SVO), or MO₆S₈; wherein said active material comprises particles having an average diameter of greater than 1 μm to about 100 μm. The active material may comprise particles having an average diameter of greater than 1 μm to about 50 μm or about 2 μm to about 30 μm. The positive foil substrate may comprise a material chosen from the group consisting of: aluminum, stainless steel, titanium, nickel, molybdenum, platinum iridium, and copper. The positive foil substrate may have a thickness of about 1-50 μm or about 1-20 μm. The active material may comprise CFₓ, and the coating may have a thickness of 10 μm to 250 μm. The active material may comprise SVO and the coating may have a thickness of 2 μm to 200 μm.

Also disclosed is an electrode assembly comprising: a negative electrode; and a positive electrode as described above. The negative electrode may comprise a negative active material on a negative foil substrate. The negative foil substrate may be chosen from the group consisting of copper, nickel, titanium, stainless steel, and aluminum. The negative foil substrate may have a thickness of about 1-50 μm or about 1-20 μm. The negative active material may partially cover both faces of the negative foil substrate. The negative electrode may comprise lithium. The positive and negative electrodes may be wound to form a jellyroll. The assembly may further comprise an elongate pin around which said electrodes are wound. The pin may be electrically conductive. A portion of the pin may form a battery terminal. One of the electrodes may be directly connected to the pin. One of the electrodes may be connected to the pin by welding an interface material to the electrode and to the pin. The assembly may further comprise at least one separator separating the electrodes. An outer layer of the electrode assembly may comprise the separator.

Also disclosed is an electric storage battery including: a case comprising a peripheral wall defining an interior volume; an electrode assembly as described above mounted in said interior volume; and an electrolyte. The case peripheral wall may define an exterior width of less than 3 mm. The case may have an exterior volume of less than 1 cm³, less than 0.5 cm³, or less than 0.1 cm³. The case peripheral wall may define a cross sectional area of less than about 7 mm². The case may be hermetically sealed.

Also disclosed is a method for making an electrode comprising the acts of: providing a foil substrate; forming a slurry comprising an active material comprising particles having an average diameter of greater than 1 μm to about 100 μm; and coating the slurry onto both faces of the foil substrate. The act of providing a substrate may comprise providing an aluminum foil substrate. The act of forming a slurry may comprise mixing said active material, polytetrafluoroethylene, carbon black, and carboxy methylcellulose. The active material may comprise SVO. The active material may comprise CFₓ. The method may further comprise the act of compressing the coated foil substrate.

Also disclosed is a method for making an electrode comprising the acts of: providing a foil substrate; forming a slurry comprising: an active material comprising particles having an average diameter of greater than 1 μm to about 100 μm, polytetrafluoroethylene, carbon black, and carboxy methylcellulose; and coating said slurry onto the foil substrate. The act of providing a foil substrate may comprise providing an aluminum foil substrate. The act of coating the slurry onto the foil substrate may comprise coating the slurry onto both faces of the foil substrate. The method may further comprise the act of compressing the coated-foil substrate.

Also disclosed is a method for making an electrode comprising the acts of: providing a negative foil substrate; and laminating lithium foil onto both faces of the negative foil substrate, leaving a portion of the negative foil substrate free of lithium, wherein said lithium foil has a thickness of between 1.5μ and 130 μm. The act of providing a negative substrate may comprise providing a negative foil substrate chosen from the group consisting of copper, nickel, titanium, stainless steel, and aluminum. The act of providing a negative substrate may comprise providing a negative substrate having a thickness of about 1 μm to about 50 μm or about 1 μm to about 20 μm.

Also disclosed is a method for making an electrode assembly comprising the acts of: forming a negative electrode comprising the acts of: providing a negative foil substrate; providing lithium foil having a thickness of 1.5 μm to 50 μm; and laminating the lithium foil onto both faces of the negative foil substrate, leaving a portion of the negative foil substrate free of lithium; forming a positive electrode comprising the acts of: providing a positive foil substrate; and coating a slurry on both faces of the positive foil substrate, wherein the coating comprises SVO; drying the coating; and compressing the positive electrode such that the coating has a thickness of between about 2 μm and about 200 μm; and winding together the negative and positive electrodes to form a spiral roll.

Also disclosed is a method for making an electrode assembly comprising the acts of: forming a negative electrode comprising the acts of: providing a negative foil substrate; providing lithium foil having a thickness of 4 μm to 130 μm; and laminating lithium foil onto both faces of the negative foil substrate, leaving a portion of the negative foil substrate free of lithium; providing a positive electrode comprising the acts of: providing a positive foil substrate; coating a slurry on both faces of the positive foil substrate, wherein the coating comprises CFₓ; drying the coating; and compressing the positive electrode such that the coating has a thickness of between about 10 μm and about 250 μm; and winding together the negative and positive electrodes to form a spiral roll.

Also disclosed is a hermetically sealable electric storage battery comprising: a case having an open end; an end cap; a first electrically conductive terminal extending through and electrically insulated from the end cap; an electrode assembly disposed within the case and comprising first and second opposite polarity electrodes separated by separators wherein the first electrode is electrically coupled to the first terminal; a flexible conducive tab electrically coupled to the second electrode proximate a first location at the case open end; the tab electrically connected to the end cap at a second location whereby the end cap has a first bias position tending to keep the case open end open and a second bias position tending to maintain case closure of the case open end. The first bias position may orient the end cap approximately perpendicular to the open end. The end cap may be welded to the tab flat against an inner face of the end cap. If the end cap has a width W; and the distance from the second location to the case open end is a length L; the L is preferably less than or equal to W. The second location may be above the center of the end cap in the first bias position. The end cap may overlap the case by approximately W/4 in the first bias position.

Also disclosed is an electric storage battery including: a case comprising a peripheral wall defining an interior volume and a cross sectional area less than 7 mm²; and an electrode assembly mounted in the interior volume, the electrode assembly including first and second opposite polarity electrode strips wound together to form a spiral roll. The case may be hermetically sealed. The electric storage battery may be rechargeable or primary. The battery may be a lithium or lithium ion battery. The electrode assembly may further include: an electrically conductive elongate pin; and wherein each electrode strip has inner and outer ends, wherein the first electrode strip is electrically coupled to the pin at said inner end.

### BRIEF DESCRIPTION OF THE FIGURES

FIG. 1 is a side view of a feedthrough pin subassembly in accordance with the invention;

FIG. 2 is a longitudinal sectional view through the subassembly of FIG. 1;

FIG. 3 is a plan view of a positive electrode strip utilized in the exemplary preferred electrode assembly in accordance with the invention;

FIG. 4 is a side view of the positive electrode strip of FIG. 3;

FIG. 5 is an enlarged sectional view of the area A of FIG. 4 showing the inner end of the positive electrode strip of FIGS. 3 and 4;

FIG. 6 is an isometric view showing the bared inner end of the positive electrode substrate spot welded to the feedthrough pin;

FIG. 9 is an isometric view depicting a drive key;

FIG. 10 is a plan view showing the drive key coupled to a drive motor for rotating the mandrel;

FIG. 11 is a schematic end view depicting how rotation of the mandrel and pin can wind positive electrode, negative electrode, and separator strips to form a spiral jellyroll electrode assembly;

FIG. 12 is a plan view of a negative electrode strip utilized in the exemplary preferred electrode assembly in accordance with the invention;

FIG. 13 is a side view of the negative electrode strip of FIG. 12;

FIG. 14 is an enlarged sectional view of the area A of FIG. 13 showing is the inner end of the negative electrode strip of FIGS. 12 and 13;

FIG. 15 is an enlarged sectional view of the area B of FIG. 13 showing the outer end of the negative electrode strip of FIGS. 11 and 12;

FIG. 16A and 16B are an isometric and cross section views, respectively, showing the layers of a spirally wound electrode assembly, i.e., jellyroll;

FIG. 17 is a plan view of the negative electrode strip showing the attachment of a flexible electrically conductive tab to the bared outer end of the negative electrode substrate;

FIG. 18 is an enlarged sectional view showing how the outer turn of the negative electrode strip is taped to the next inner layer to close tie jellyroll to minimize its outer radius dimension;

FIG. 19 is an isometric view depicting the jellyroll electrode assembly being inserted into a cylindrical battery case body;

FIG. 20 is an isometric view showing a battery case body with the negative electrode tab extending from the open case body;

FIG. 21 is an isometric view showing how the negative electrode tab is mechanically and electrically connected to an endcap for sealing the case body second end;

FIG. 22 is a side view showing how the negative electrode tab holds the second endcap proximate to the case body second end without obstructing the open second end;

FIGS. 23A and 23B are front views showing the weld position and the relationship between the various components;

FIG. 24 is an enlarged sectional view of the second end of the battery case showing the endcap in sealed position; and

FIGS. 25-27 show an alternative structure and method for attaching an electrode to a pin.

### DETAILED DESCRIPTION

The present invention is directed to an electric storage battery incorporating one or more aspects described herein for enhancing battery reliability while minimizing battery size. In addition, the invention is directed to a method for efficiently manufacturing the battery at a relatively low cost.

Electric storage batteries generally comprise a tubular metal case enveloping an interior cavity which contains an electrode assembly surrounded by a suitable electrolyte. The electrode assembly generally comprises a plurality of positive electrode, negative electrode, and separator layers which are typically stacked and/or spirally wound to form a jellyroll. The positive electrode is generally formed of a metal substrate having positive active material coated on both faces of the substrate. Similarly, the negative electrode is formed of a metal or other electrically conductive substrate having negative active material coated on both faces of the substrate. In forming an electrode assembly, separator layers are interleaved between the positive and negative electrode layers to provide electrical isolation.

For secondary batteries of the present invention, the positive active material may comprise, for example, MOS₂, MnO₂, V₂O₅, or a lithium cobalt oxide. The negative active material may comprise, for example, lithium metal, lithium alloy, or a carbonaceous negative active material known in the art such as graphite. For primary batteries according to the present invention, the positive active material may comprise, for example, Bi₂′o₃, Bi₂Pb₂O₅, fluorinated carbon (CFₓ), CuCl₂, CuF₂, CuO, Cu₄O(PO₄)₂, CuS, FeS, FeS₂, MnO₂, MoO₃, Ni₃S₂, AgCl, Ag₂CrO₄, V₂O₅ and related compounds, silver vanadium oxide (SVO), or MO₆S₈. The negative active material may comprise lithium metal.

For most of the active materials described herein, including CFₓ, SVO, and CuS, the active material preferably comprises a powder having an average particle diameter of greater than 1 μm to about 100 μm, more preferably greater than 1 μm to about 50 μm, and most preferably about 2 μm to about 30 μm. For some of the materials, however, especially some of the secondary positive active materials such as CoO₂ and MnO₂, the average particle diameter is most preferably about 5 to 6 μm.

In accordance with a first significant aspect of the invention, a feedthrough pin is provided which is directly physically and electrically connected to the inner end of an electrode substrate (e.g., positive), as by welding. The pin is used during the manufacturing process as an arbor to facilitate winding the layers to form an electrode assembly jellyroll. Additionally, in the fully manufactured battery, the pin extends through a battery case endcap and functions as one of the battery terminals. The battery case itself generally functions as the other battery terminal.

One alternative to the direct connection of the substrate to the feedthrough pin is the use of an interface material. In designs in which the electrode substrate and pin materials are not matched for direct welding, this interface material serves as an intermediate material that is weldable to both the substrate and the pin. This feature improves the mechanical strength of the joint between the electrode assembly and the pin for improved winding and performance. This improvement makes the connection between the components easily adaptable to design and material changes and simplifies processing.

More particularly, in accordance with an exemplary preferred embodiment, the inner end of the positive electrode substrate is spot welded to the feedthrough pin to form an electrical connection. The substrate, e.g., aluminum, can be very thin, e.g., 0.02 mm, making it difficult to form a strong mechanical connection to the pin, which is preferably constructed of a low electrical resistance, highly corrosion resistant material, e.g., platinum iridium, and can have a diameter on the order of 0.40 mm.

In order to mechanically reinforce the pin and secure the pin/substrate connection, a slotted Cshaped mandrel may be provided. The mandrel is formed of electrically conductive material, e.g., titanium-6AI-4V, and is fitted around the pin, overlaying the pin/substrate connection. The mandrel is then preferably welded to both the pin and substrate. The mandrel slot defines a keyway for accommodating a drive key which can be driven to rotate the mandrel and pin to wind the electrode assembly layers to form the spiral jellyroll.

In accordance with a further significant aspect of the invention, the outer layer of the jellyroll is particularly configured to minimize the size, i.e., outer radius dimension, of the jellyroll. More particularly, in the exemplary preferred embodiment, the active material is removed from both faces of the negative electrode substrate adjacent its outer end. The thickness of each active material coat can be about 0.04 mm and the thickness of the negative substrate can be about 0.005 mm. By baring the outer end of the negative electrode substrate, it can be adhered directly, e.g., by an appropriate adhesive tape, to the next inner layer to close the jellyroll to while minimizing the roll outer radius dimension.

A battery case in accordance with the invention is comprised of a tubular case body having open first and second ends. The feedthrough pin preferably carries a first endcap physically secured to, but electrically insulated from, the pin. This first endcap is preferably secured to the case body, as by laser welding, to close the open first end and form a leak free seal. With the jellyroll mounted in the case and the first endcap sealed, the interior cavity can thereafter be filled with electrolyte from the open second end.

In accordance with a still further aspect of the invention, the jellyroll assembly is formed with a flexible electrically conductive tab extending from the negative electrode substrate for electrical connection to the battery case. The tab may simply be a bare portion of the substrate. Alternatively, a separate tab may be welded to a bare portion of the substrate. As yet another alternative, the negative electrode may consist of a foil without a substrate, such as lithium metal foil or lithium aluminum alloy foil; a tab may be directly mechanically and electrically coupled to the lithium metal foil. In accordance with a preferred embodiment, the tab is welded to a second endcap which is in turn welded to the case. The tab is sufficiently flexible to enable the second endcap to close the case body second end after the interior cavity is filled with electrolyte via the open second end. In accordance with an exemplary preferred embodiment, the tab is welded to the inner face of the second endcap such that when the jellyroll is placed in the body, the tab locates the second endcap proximate to the body without obstructing the open second end. After electrolyte filling, the case body is sealed by bending the tab to position the second endcap across the body second end and then laser welding the endcap to the case body.

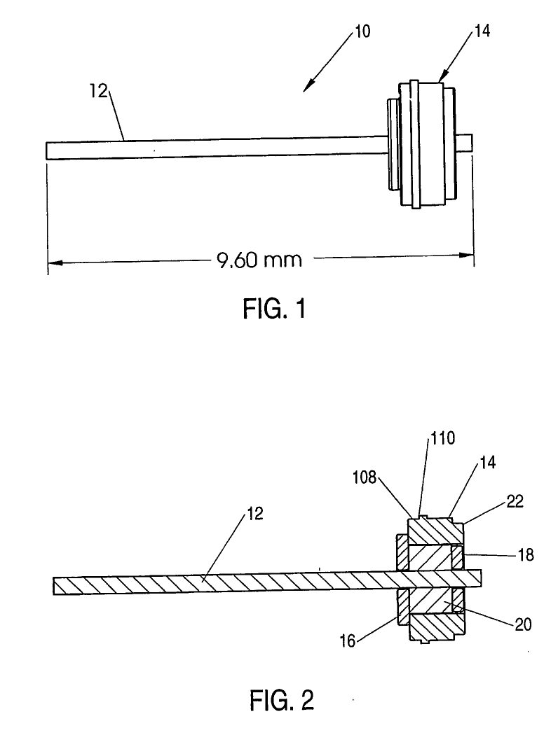

Attention is initially directed to FIGS. 1 and 2 which illustrate a preferred feedthrough pin subassembly 10 utilized in accordance with the present invention. The subassembly 10 is comprised of an elongate pin 12, preferably formed of a solid electrically conductive material, having low electrical resistance and high corrosion resistance. For a positively charged pin, the material is preferably platinum iridium, and more preferably 90Pt/10Ir. For a negatively charged pin, the pin material is chosen such that it does not react with the negative active material; commercially pure titanium (CP Ti) is a preferred material for negative pins. The pin 12 extends through, and is hermetically sealed to a header 14. The header 14 is comprised of dielectric disks, e.g., ceramic, 16 and 18 which sandwich a glass hollow cylinder 20 therebetween. The glass hollow cylinder is hermetically sealed to the pin 12. The outer surface of the glass hollow cylinder 20 is sealed to the inner surface of an electrically conductive hollow member 22, e.g., titanium-6AI-4V. As will be seen hereinafter, the conductive hollow material 22 functions as a battery case endcap in the final product to be described hereinafter.

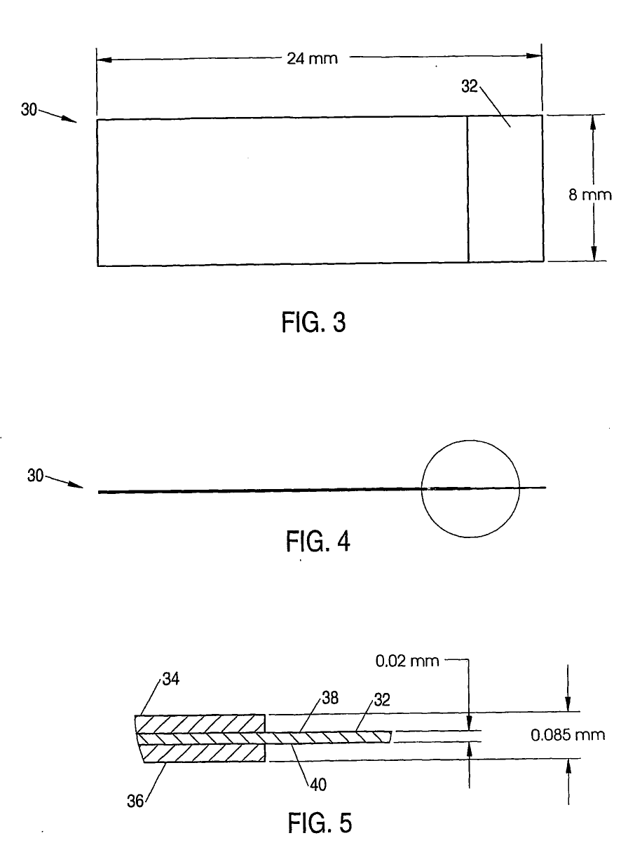

Attention is now directed to FIGS. 3, 4, and 5 which illustrate a preferred positive electrode strip 30 which is utilized in the fabrication of a preferred spirally wound jellyroll electrode assembly in accordance with the present invention. The positive electrode strip 30 is comprised of a metal substrate 32 formed, for example, of aluminum. Positive electrode active material 34, 36 is deposited, respectively on the upper and lower faces 38 and 40 of the substrate 32. Note in FIGS. 3, 4, and 5 that the right end of the substrate 32 is bare, i.e. devoid of positive active material on both the upper and lower faces 38, 40.

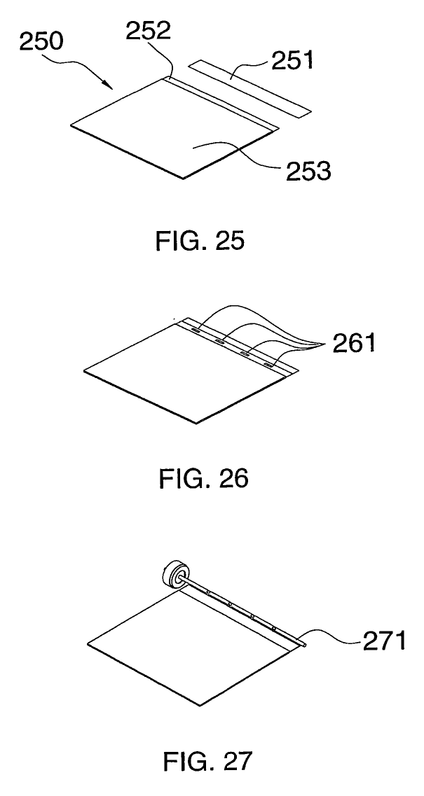

FIGS. 25 through 27 illustrate an alternative method of joining a substrate 252 to a pin 271 using an interface material 251. In a preferred configuration, interface material 251 is welded to the substrate 252 of a positive electrode 250. Preferably, interface material 251 comprises a titanium material and electrode 250 comprises an aluminum substrate 252 having active materials 253 disposed on both sides. FIG. 25 shows the interface material 251 before joining to the electrode. It preferably is dimensioned to have a length approximately the same length as the edge of the substrate to which it will be welded. FIG. 26 shows interface material 251 welded to substrate 252 at at least one weld location 261. FIG. 27 shows pin 271 welded to interface material 251, preferably using a resistance weld for good electrical contact, with ultra sonic welding being an alternative method.

It is to be pointed out that exemplary dimensions are depicted in FIGS. 1-5 and other figures herein. These exemplary dimensions are provided primarily to convey an order of magnitude to the reader to facilitate an understanding of the text and drawings. Although the indicated dimensions accurately reflect one exemplary embodiment of the invention, it should be appreciated that the invention can be practiced utilizing components having significantly different dimensions.

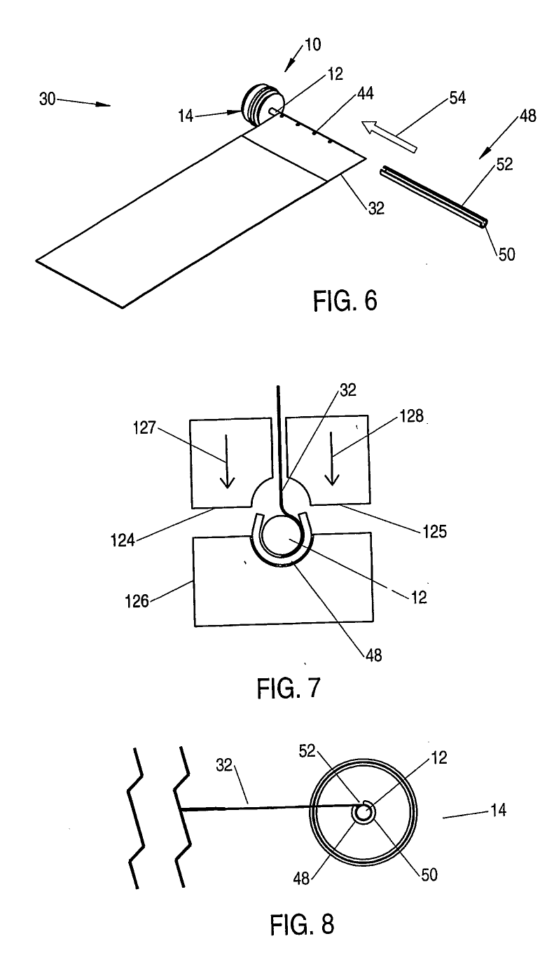

FIG. 6 depicts an early process step for manufacturing a battery in accordance with the invention utilizing the pin subassembly 10 (FIGS. 1, 2) and the positive electrode strip 30 (FIGS. 3-5). A topside electrode insulator (not shown), which may comprise a thin disk of DuPont KAPTON® polyimide film, is slipped onto the pin 12 adjacent the header 14. In accordance with the present invention, the bare end of the electrode strip substrate 32 is electrically connected to the pin 12 preferably by resistance spot welding, shown at 44. Alternatively, substrate 32 may be ultrasonically welded to the pin 12. The thinness, e.g. point 0.02 mm of the substrate 32, makes it very difficult to form a strong mechanical connection between the substrate and the pin 12. Accordingly, in accordance with a significant aspect of the present invention, an elongate C-shaped mandrel 48 is provided to mechanically reinforce the pin 12 and secure the substrate 32 thereto.

The mandrel 48 preferably comprises an elongate titanium or titanium alloy such as Ti-6AI-4V tube 50 having a longitudinal slot 52 extending along the length thereof. The arrow 54 in FIG. 6 depicts how the mandrel 48 is slid over the pin 12 and substrate 32, preferably overlaying the line of spot welds 44. The mandrel 48, pin 12, and substrate 32 are then preferably welded together, such as by resistance spot welding or by ultrasonic welding. Alternatively, the mandrel 48 may be crimped onto the pin 12 at least partially closing the “C” to create a strong mechanical connection. In the case of forming only a mechanical connection and not necessarily a gas-tight electrical connection between the mandrel 48 and the pin and substrate, the mandrel material is preferably made of a material that will not lead to electrolysis. When used with electrolytes that tend to contain hydrofluoric acid, the mandrel is preferably made of 304, 314, or 316 stainless steels or aluminum or an alloy thereof chosen for its compatibility with the other materials. FIG. 7 is an end view showing the step of crimping the mandrel 48 to the pin 12 and substrate 32. Supporting die 126 is used to support the mandrel 48 and crimping dies 124 and 125 are used to deform the edges of the mandrel 48 to bring them closer together and mechanically connect the mandrel 48 to the pin 12 and substrate 32. By crimping in the direction of arrows 127 and 128, a strong connection is formed without damaging the thin electrode or disturbing the electrical connection between the pin and the electrode.

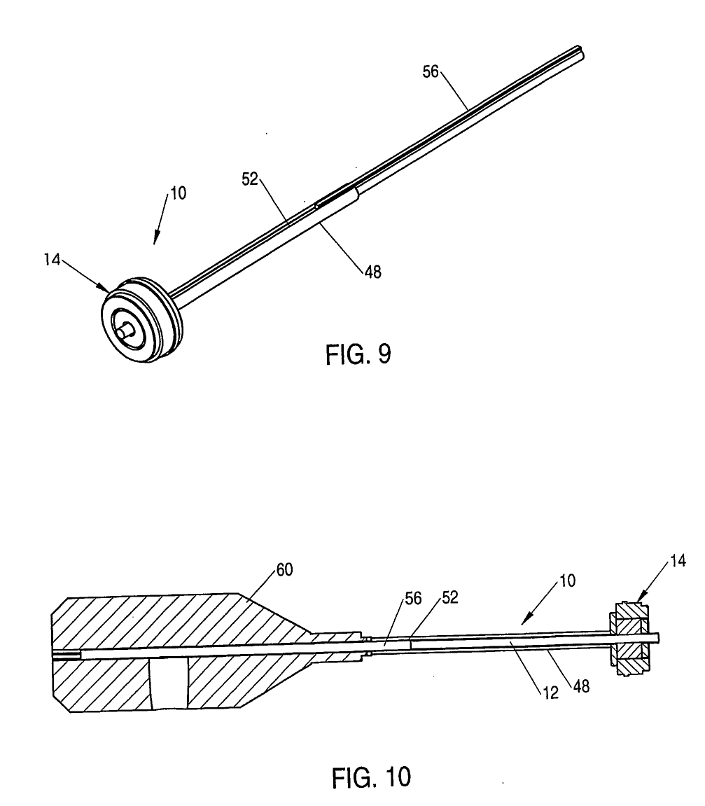

FIG. 8 is an end view showing the slotted mandrel 48 on the pin 12 with the substrate 32 extending tangentially to the pin 12 and terminating adjacent the interior surface of the mandrel tube 50. The tube 50 is preferably sufficiently long so as to extend beyond the free end of the pin 12. As depicted in FIG. 9, this enables a drive key 56 to extend into the mandrel slot 52.

FIG. 10 schematically depicts a drive motor 60 for driving the drive key 56 extending into mandrel slot 52. With the pin subassembly header 14 supported for rotation (not shown), energization of the motor 60 will orbit the key drive 56 to rotate the mandrel 48 and subassembly 10 around their common longitudinal axes. The rotation of the mandrel 48 and subassembly 10 is employed to form a jellyroll electrode assembly in accordance with the present invention.

More particularly, FIG. 11 depicts how a jellyroll electrode assembly is formed in accordance with the present invention. The bare end of the substrate 32 of the positive electrode strip 30 is electrically connected to the pin 12 as previously described. The conductive mandrel 48 contains the pin 12 and bare substrate end, being welded to both as previously described. A strip of insulating separator material 64 extending from opposite directions is introduced between the mandrel 48 and positive electrode substrate 32, as shown. A negative electrode strip 70 is then introduced between the portions of the separator material extending outwardly from mandrel 48.

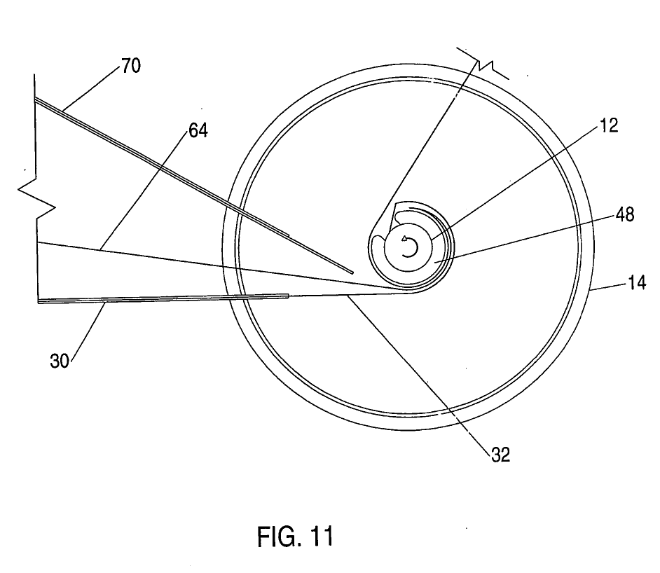

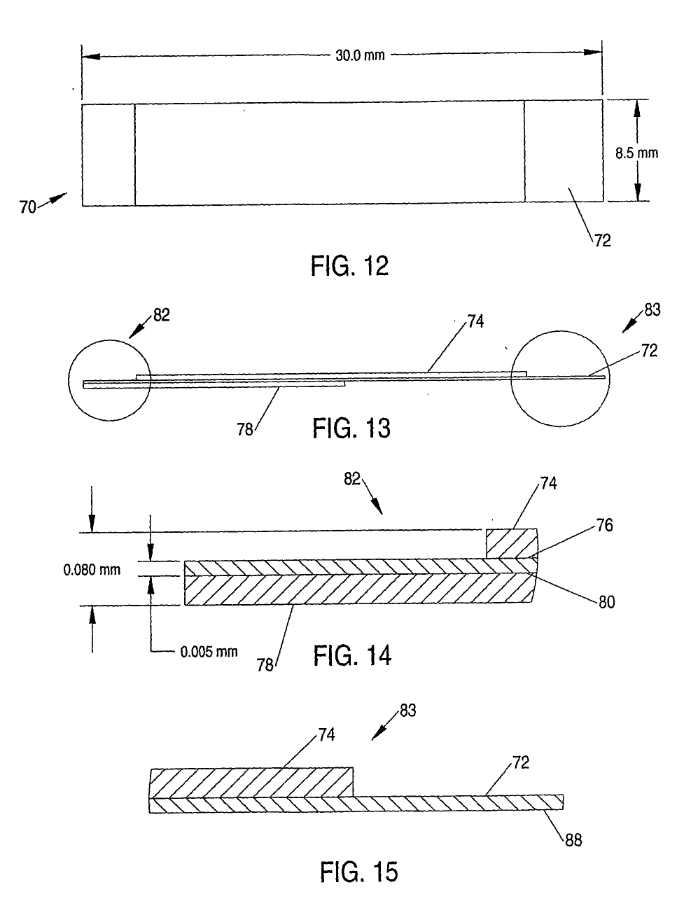

The preferred exemplary negative electrode strip 70 is depicted in FIGS. 12-15. The negative electrode strip 70 is comprised of a substrate 72. e.g. titanium, having negative active material formed on respective faces of the substrate. More particularly, note in FIG. 14 that negative active material 74 is deposited on the substrate upper surface 76 and negative active material 78 is deposited on the substrate lower surface 80. FIG. 14 depicts the preferred configuration of the inner end 82 of the negative electrode strip 70 shown at the left of FIGS. 12 and 13. FIG. 15 depicts the configuration of the outer end 83 of the negative electrode strip 70 shown at the right side of FIGS. 12 and 13.

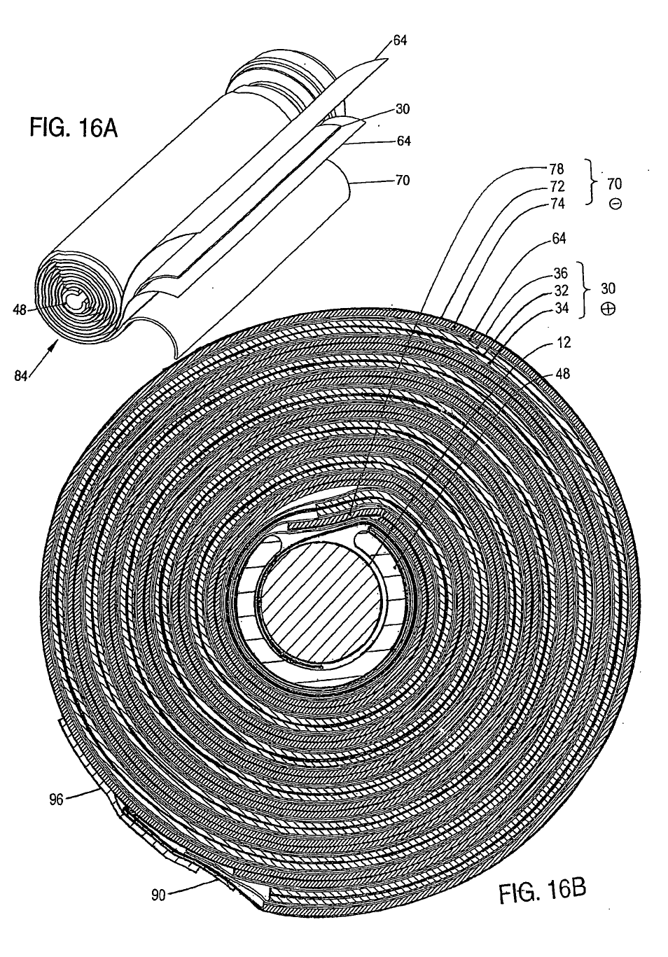

Note in FIG. 14 that one face of the substrate inner end 82 is bared. This configuration can also be noted in FIG. 11 which shows how the negative substrate inner end 82 is inserted between turns of the separator strip 64. After the strip 70 has been inserted as depicted in FIG. 11, the aforementioned drive motor 60 is energized to rotate pin 12 and mandrel 48, via drive key 56, in a counterclockwise direction, as viewed in FIG. 11. Rotation of pin 12 and mandrel 48 functions to wind positive electrode strip 30, separator strip 64, and negative electrode strip 70, into the spiral jellyroll assembly 84, depicted in FIG. 16 A. The assembly 84 comprises multiple layers of strip material so that a cross section through the assembly 84 reveals a sequence of layers in the form pos/sep/neg/sep/pos/sep/neg/ . . . , etc., as shown in FIG. 16B.

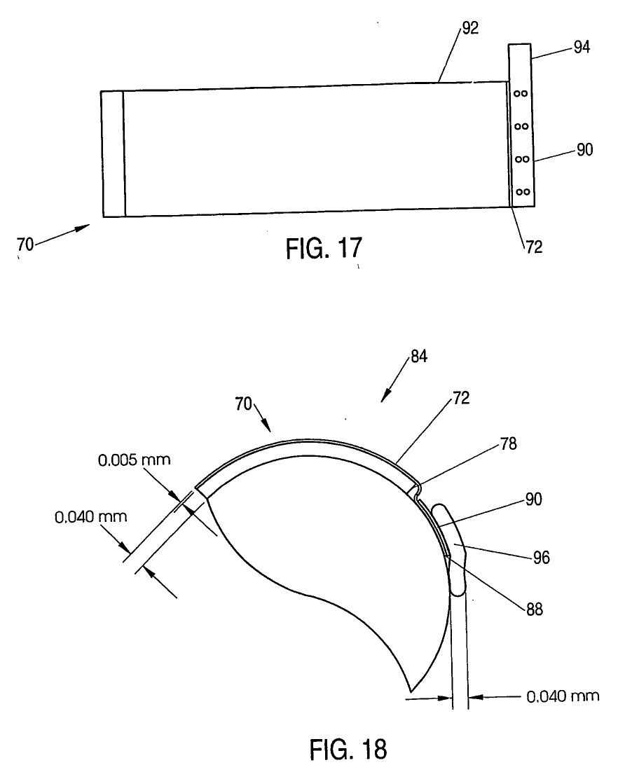

FIG. 15 depicts a preferred configuration of the outer end 83 of the negative electrode strip 70. Note that the outer end 88 of the substrate 72 is bare on both its top and bottom faces. These bared portions may be provided by masking the substrate prior to coating, by scraping active material after coating, or by other means well known in the art. Additionally, as shown in FIG. 17, a flexible metal tab 90 is welded crosswise to the substrate 72 so as to extend beyond edge 92. More particularly, note that portion 94 of tab 90 is cantilevered beyond edge 92 of negative electrode strip 70. This tab portion, as will be described hereinafter, is utilized to mechanically and electrically connect to an endcap for closing a battery case.

Attention is now called to FIG. 18, which illustrates a preferred technique for closing the jellyroll assembly 84. That is, the bare end 88 of the negative electrode substrate 72 extending beyond the negative active material coat 78 is draped over the next inner layer of the jellyroll assembly 84. The end 88 can then be secured to the next inner layer, e.g., by appropriate adhesive tape 96. One such suitable adhesive tape is DuPont KAPTON® polyimide tape. It is important to note that the outer end configuration 88 of the negative electrode strip 70 enables the outer radius dimension of the jellyroll assembly 84 to be minimized as shown in FIG. 18. More particularly, by baring the substrate 72 beyond the active material 78, the tape 96 is able to secure the substrate end without adding any radial dimension to the jellyroll assembly. In other words, if the outer end of the substrate were not sufficiently bared, then the tape 96 would need to extend over the active material and thus add to the outer radius dimension of the jellyroll 84. Furthermore, the bare substrate 72 is more flexible than the substrate coated with active material 78 and conforms more readily to the jellyroll assembly 84, making it easier to adhere it to the surface of the jellyroll. These space savings, although seemingly small, can be clinically important in certain medical applications. It should be noted that the electrode need only be bared at an end portion long enough to accommodate the tape 96, as shown in FIG. 18. Because the uncoated substrate does not function as an electrode, it would waste space in the battery to bare any more than necessary to accommodate the tape. In a preferred embodiment, the length of uncoated substrate is between 1 and 8 mm, and more preferably about 2 mm. In some embodiments, as illustrated, the outer layer is an electrode layer, and the tape is applied to the outer electrode layer. However, in other embodiments, to facilitate insertion of the electrode assembly into the battery case, the outer layer is a separator layer to keep the outer electrode layer from sticking to the inside of the battery case during insertion. This configuration is particularly useful in a battery when the outer electrode layer is lithium metal, which tends to grab onto the case material during insertion.

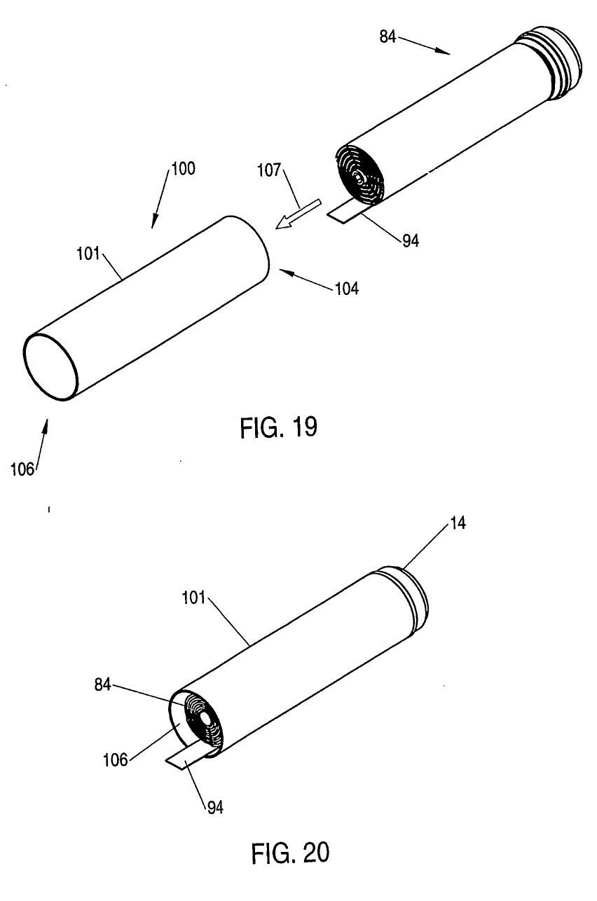

FIG. 19 depicts the completed jellyroll assembly 84 and shows the cantilevered tab portion 94 prior to insertion into a battery case body 100. The case body 100 is depicted as comprising a cylindrical metal tube 101 having an open first end 104 and open second end 106. In a preferred embodiment in which small volume and weight are desirable, the case body 100 comprises Ti-6AI-4V alloy or stainless steel, and is less than 0.25 mm (0.010 inches) thick, and more preferably less than 0.125 mm (0.005 inches) thick, and most preferably less than 0.076 mm (0.003 inches) thick. Arrow 107 represents how the jellyroll assembly 84 is inserted into the cylindrical tube 101. FIG. 20 depicts the jellyroll assembly 84 within the tube 101 with the cantilevered negative electrode tab 94 extending from the case open second end 106. The case open first end 104 is closed by the aforementioned header 14 of the pin subassembly 10 shown in FIGS. 1 and 2. More particularly, iiote that the metal hollow member 22 is configured to define a reduced diameter portion 108 and shoulder 110. The reduced diameter portion 108 is dimensioned to fit into the open end 104 of the cylindrical tube 101 essentially contiguous with the tube's inner wall surface. The shoulder 110 of the hollow member 22 engages the end of the case tube 101. This enables the surfaces of the reduced diameter portion 108 and shoulder 110 to be laser welded to the end of the case 100 to achieve a hermetic seal.

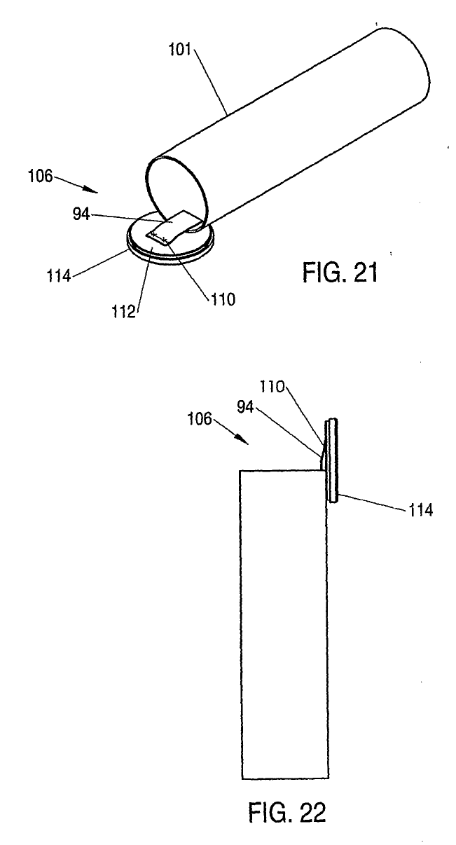

Attention is now directed to FIGS. 21-24, which depict the tab 94 extending from the second open end 106 of the case tube 101. Note that the tab 94 extends longitudinally from the body close to the case tube adjacent to tube's inner wall surface. In accordance with a preferred embodiment of the invention, the tab 94 is welded at 110 to the inner face 112 of a circular second endcap 114. In accordance with a preferred embodiment, the tab 94 is sufficiently long to locate the weld 110 beyond the center point of the circular endcap 114. More particularly, note in FIGS. 21-24 that by locating the weld 110 displaced from the center of the cap 114, the tab 94 can conveniently support the endcap 114 in a vertical orientation as depicted in FIG. 22 misaligned with respect to the open end 106. This end cap position approximately perpendicular to the end 122 of the case 100 is a first bias position wherein the end cap advantageously tends to remain in that orientation with the case end open prior to filling.

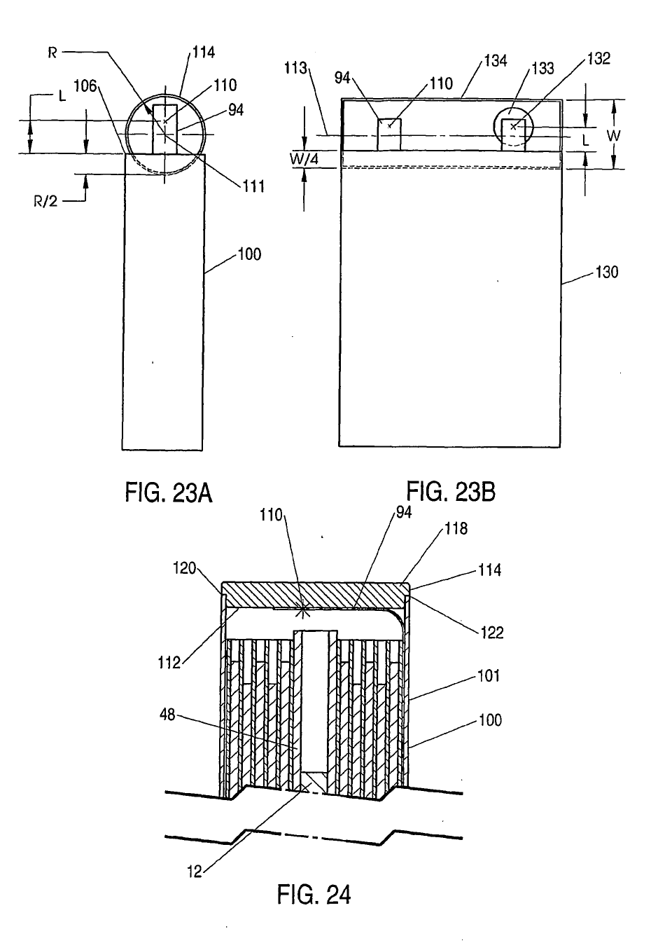

To further describe the relationship between the weld location and the various components, FIG. 23A shows a front view with various dimensions. L represents the length from the weld 110 to the top of the case 100 as measured parallel to the edge of the case. R is the radius of the end cap 114. For the preferred geometry, L≦2R. Weld 110 is preferably made above the center point 111 of the end cap 114. Preferably, the end cap 114 overlaps the case 100 by approximately R/2. By configuring the tab 94 and weld 110 as indicated, the endcap 114 can be supported so that it does not obstruct the open end 106, thereby facilitating electrolyte filling of the case interior cavity via open end 106. A filling needle or nozzle can be placed through open end 106 to fill the case. This obviates the need for a separate electrolyte fill port, thereby reducing the number of components and number of seals to be made, thus reducing cost and improving reliability. Furthermore, for small medical batteries, the end caps would be very small to have fill ports therein. In a preferred embodiment in which the case wall is very thin, for example, about 0.002 inches (about 50 μm), providing a fill port in the side wall of the case would be impractical. Even in the case of larger devices where space is less critical and the wall is more substantial, providing a fill port in the side of the case would mean the electrolyte would have a very long path length to wet the jellyroll. Note that while the case could be filled with electrolyte prior to welding tab 94 to endeap 114, it would be difficult and messy to do so. Therefore, it is advantageous to configure the tab 94 and weld 110 as described to allow the weld to be made prior to filling.

Although the preferred geometry for welding the tab to the endcap and case has been described in terms appropriate for a circularly cylindrical case, this geometry can be easily applied to battery cases having noncircular cross sections. For example, as shown in FIG. 23B, for a case having a rectangular cross section, the dimension W is the width of the case lid measured in the direction parallel to the case when the lid is in its open position as shown in FIG. 23B. As, in the above configuration, L represents the length from the weld 110 to the top of the case 130. In the preferred geometry, L≦W. Weld 110 connects tab 94 to endcap 134, and is preferably made above the center line 113 of the endcap 134. A second tab 132 may be present to connect the opposite polarity electrode to a feedthrough pin at weld 132, which is insulated from endcap 134 by an insulator 133, which may comprise glass or nonglass ceramic or an insulative polymer. When the second tab is used, it preferably is configured to the same geometry as described for tab 94.

Preferably before filling, a bottomside electrode insulator (not shown), which may comprise a thin disk of DuPont KAPTON® polyimide film, is installed into the case between the rolled electrode assembly and the still open end of the battery case.

In a preferred filling method, there is a channel of air between the pin and the crimped or welded C-shaped mandrel, which is used as a conduit for quickly delivering the electrolyte to the far end of the battery and to the inside edges of the electrodes within the jellyroll. Filling from the far end of the battery prevents pockets of air from being trapped, which could form a barrier to further filling. This facilitates and speeds the filling process, ensuring that electrolyte wets the entire battery.

Thereafter, the flexible tab 94 can be bent to the configuration depicted in FIG. 24. Note that the endcap 114 is configured similarly to header hollow member 22 and includes a reduced diameter portion 118 and a shoulder 120. The reduced diameter portion snugly fits against the inner surface of the wall of tube 101 with the endcap shoulder 120 bearing against the end 122 of the cylindrical case 100. The relatively long length of the tab 94 extending beyond the center point of the endcap surface 112 minimizes any axial force which might be exerted by the tab portion 94 tending to longitudinally displace the endcap 114. The end cap position covering the end 122 of the case 100 is a second bias position wherein the end cap advantageously tends to remain in that orientation prior to welding. With the endcap in place, it can then be readily welded to the case wall 101 to hermetically seat the battery. With tab 90 welded to negative substrate 72 and with the negative electrode strip 70 as the outermost layer of the jellyroll, the endcap 114 becomes negative. In turn, welding the endcap 114 to the case 100 renders the case negative.

In a preferred embodiment of a primary battery of the present invention, a cathode is formed by coating a slurry of primary positive active material such as Bi₂O₃, Bi₂Pb₂O₅, fluorinated carbon (CFₓ), CuCl₂, CuF₂, CuO, Cu₄O(PO₄)₂, CuS, FeS, FeS₂, MnO₂, MoO₃, Ni₃S₂, AgCl, Ag₂CrO₄, V₂O₅ and related compounds, silver vanadium oxide (SVO), or MO₆S₈, most preferably CFₓ, onto both faces of a positive substrate. The slurry preferably comprises at least one such active material and at least one binder, such as poly(vinylidene) fluoride (PVdF). A combination of binders, such as polytetrafluoroethylene (PTFE) and carboxy methylcpllulose (CMC), may be used. 1-10 wt % PTFE with 1-15 wt % CMC with 65-98 wt % CFₓ is a preferred combination, providing a good consistency for manufacturability. Aqueous or nonaqueous binders may be used, with some examples of nonaqueous binders including PVdF, 1-methyl-2-pyrrolidinone (NMP), polyacrylic, and polyethylene oxide, and combinations thereof. The slurry may also comprise a conductive additive such as a carbonaceous material, such as acetylene black, carbon black, or graphite in an amount up to 20 wt %. The positive substrate is preferably aluminum having a thickness of 1 to 100 μm, and more preferably 1 to 20 μm. Other positive substrates may be used, such as stainless steel (SS), Ti, Ni, Mo, PtIr, and Cu, depending on the active material and its intrinsic maximum potential. For high voltage applications, preferred substrates are Al, SS, Ti, and Ni; for low voltage applications, Cu is preferred because of its high conductivity. The cathode is dried and then preferably pressed in order to achieve the desired porosity.

The anode preferably comprises copper substrate, having a thickness of 1 μm to 100 μm, and more preferably 1 to 20 μm, and most preferably about 5 μm, and having lithium laminated on both faces. Other negative substrates may be used, such as Ti, Ni, and stainless steel. Al may be used in applications where it is desirable to stabilize lithium by forming an alloy with it. Applying active material to both faces of each of the positive and negative substrates allows maximum use of the substrates' available area.

Both positive and negative substrates preferably comprise a foil and are preferably not mesh or mesh-like, such as perforated or expanded foil. Although mesh has been used in the past as a current collector for Li, CFₓ, and SVO because it is easy to press the material onto it, the present inventors have found that because of the current gradient between the metal strips and the holes in the mesh, for high rate applications, the current distribution is uneven. Furthermore, the present inventors have found that changes to the electrode surface during discharge, such as material expansion, are amplified by the presence of a mesh. The electrode surface loses its initial smoothness and becomes coarse, resulting in an increase of the internal resistance of the battery and a reduced rate capability. High rate primary batteries require the use of very thin lithium electrodes. However, it is very difficult to press such thin lithium on a mesh because it is so soft. It is also common that the lithium is not supported by any current collector at all, only a tab on one side of-the electrode. Even though it is mechanically possible to use such a design for thin lithium electrodes, it is electrically not preferred because if the lithium electrode were to be used up in the middle of the electrode, the current can no longer be conducted from the tab to the isolated piece of lithium electrode. By using foil, continuous current distribution is provided, even if Li is depleted in the middle of the electrode. Furthermore, using a foil substrate provides stronger mechanical properties for die cutting, welding, winding, and stacking of electrodes. For CFₓ and SVO batteries, the reduced rate capability due to the mesh is not always observed since the common rate of discharge is low. Typical CFₓ batteries used for medical devices are discharged at rates of C/10000 to C/50. However, such a battery could not be discharged at a rate of C/2 or more. Although SVO already has a good high rate capability (>1 C), we believe its performance can still be improved if using this invention. This invention proposes a way to achieve an even current distribution, smooth electrode, and mechanical support required for high rate applications.

The cathode is welded to a nickel interface material, which is then welded to the feedthrough pin. The feedthrough pin is preferably titanium, which is especially preferable when the positive active material is CFₓ because it minimizes corrosion as compared to some of the commonly used stainless steels. The nickel interface material can be welded to both the aluminum substrate and to the titanium feedthrough pin, facilitating their connection. Other materials that can be used for a feedthrough pin include titanium, molybdenum, platinum iridium, aluminum, nickel, and stainless steel when the pin is used as the positive terminal, and include nickel, titanium, copper, molybdenum, and stainless steel when the pin is used as the negative terminal.

A separator, preferably polypropylene, and most preferably 25-μm polypropylene, such as CELGARD #2500, forms an envelope around the lithium covered copper. This enveloped negative electrode is then placed next to the positive electrode, whereby the separator prevents physical contact between the positive and negative active materials.

These layers are then wound around the feedthrough pin to create a “jellyroll”. The jellyroll is preferably fastened with DuPont KAPTON® tape and inserted into a conductive case, preferably stainless steel. The positive and negative active materials are activated with electrolyte, preferably 1.2-M LiPF₆ PC/DME 3/7, and a cap is welded to the case to seal it. In an exemplary embodiment, the case is 22 mm in length and 2.9 mm in diameter. This structure and inventive method provide higher rate capability than a typical battery, allowing the battery to be very small in size to facilitate implantation in a body.

The thickness of the active material and substrate are preferably optimized to provide both high energy density and ease of manufacturing to form a jellyroll. The dried electrode coating material, including active material, binder, and conductive additive, is preferably between about 0.001 g/cm² and about 0.03 g/cm². For a CFₓ cathode—lithium anode battery, the CFₓ thickness range is preferably 10 μm to 250 μm, and the lithium thickness range is preferably 4 μm to 130 μm. For an SVO cathode—lithium anode battery, the SVO thickness range is preferably 2 μm to 200 μm and the lithium thickness range is preferably 1.5 μm to 50 μm. These ranges are particularly well suited to forming the small sized batteries required for implantation in the body, typically less than 3 mm diameter, or esophageal applications, typically less than 5 mm diameter.

The following examples describe electric storage batteries and methods for making them according to the present invention, and set forth the best mode contemplated by the inventors of carrying out the invention, but are not to be construed as limiting. For example, alternative methods for preparing the negative electrode could be used, such as that described in copending patent application Ser. No. 10/264,870, filed Oct. 3, 2002, which is assigned to the assignee of the present invention and incorporated herein by reference in its entirety. Furthermore, although the examples given are for lithium ion rechargeable and lithium primary batteries, the present invention is not limited to lithium chemistries, and may be embodied in batteries using other chemistries. As another example, some aspects of the present invention may be used in conjunction with assembly techniques taught in U.S. Publication Nos. 2001/0046625; 2001/0053476, 2003/0003356, all of which are assigned to the assignee of the present invention and incorporated herein by reference.

### EXAMPLE 1

### Rechargeable Battery

The negative electrode was prepared by combining a mixed-shape graphite with poly(vinylidene) fluoride (PVdF) in a ratio of 85:15 in N-methyl-pyrrolidinone (NMP), then mixing to form a slurry. A 5-μm titanium foil substrate was coated with the slurry, then dried by evaporating the NMP off using heat, then compressed to a thickness of about 79 μm. Portions of negative active material were scraped off to leave certain portions of the negative substrate uncoated, as described above.

A positive active material slurry was prepared by mixing LiCo_{0.5}Ni_{0.8}Al_{0.05}O₂, polyvinylidene fluoride (PVDF) binder, graphite, acetylene black, and NMP. The slurry was coated onto both sides of a 20-μm thick aluminum foil. The positive electrode was compressed to a final total thickness of about 87 μm. Portions of positive active material were scraped off to leave certain portions of the positive substrate uncoated, as described above.

The 8.59 mm×29.14 mm-negative electrode and 7.8 mm×23.74 mm-positive electrode were then spirally wound with a layer of polyethylene separator between them, using the winding technique described above to form a jellyroll electrode assembly. Adhesive tape was applied to close the jellyroll in the manner described above. The jellyroll was inserted into a circular cylindrical Ti-6AI4V 0.05-mm thick case having a diameter of about 2.9 and a height of about 11.8 mm, for a total external volume of about 0.08 cm³. An electrolyte comprising LiPF₆ in a mixture of ethylene carbonate (EC) and diethyl carbonate (DEC) was delivered to the electrode assembly using the C-shaped mandrel as a conduit, as described above. The end of the battery case was closed, using the technique described above, hermetically sealing the case.

The battery produced in this example was suitable for implanting in a human body, being hermetically sealed and very small. In fact, due to its small diameter and circular cylindrical shape, this rechargeable battery can be used in a device inserted into the body using a syringe-like device having a needle. Preferably, for this method of implantation, the diameter of the battery is less than 3 mm. The shape of the battery produced herein is not limited to having a circular cross section, and may have a cross section that is oval, rectangular, or other shape. Preferably, the cross sectional area is less than about 7 mm². The volume is preferably less than 1 cm³, more preferably less than 0.5 cm³, and most preferably less than 0.1 cm³. Using one or a combination of the various techniques described herein allows a spirally wound jellyroll-type electrode assembly to be fit into a very small battery case of a volume not seen in the prior art. The very small battery of this example is particularly suitable for applications requiring excellent cycleability, operating at low current, such as diagnostic or other low energy applications.

For a battery to be useful at a given rate, the capacity should be higher than 70% of its capacity at a very low rate, such as 0.2C. For the cell of this example, 3 mA=1C. As shown in the table below, two batteries produced according to this example were tested for their rate capability at 37° C., charging to 4.0 V at 1.5 mA, using a 0.15 mA cutoff, and discharging at 0.6, 1.5, 3.0, 6, 9, 15, and 30 mA to 2.7 V. The batteries were found to meet the greater than 70% capacity criterion for all rates up to and including 5C. In fact, they were found to have greater than 80% capacity at rates up to 5C, greater than 90% for rates of up to 3C, and greater than 95% for rates up to 1C.

TABLE
Capacity at various rates expressed
as % of capacity at a rate of 0.2 C.

| Discharge rate | Discharge | Cell 1 | Cell 2 | Average |
|---|---|---|---|---|
| (mA) | rate (C) | % Capacity | % Capacity | % Capacity |
| 0.6 | 0.2 | 100 | 100 | 100 |
| 1.5 | 0.5 | 98.1 | 97.8 | 97.9 |
| 3.0 | 1 | 95.9 | 95.5 | 95.7 |
| 6 | 2 | 93.2 | 92.6 | 92.9 |
| 9 | 3 | 90.3 | 89.6 | 90.0 |
| 15 | 5 | 80.8 | 80.7 | 80.8 |
| 30 | 10 | 45.1 | 47.9 | 46.5 |

### EXAMPLE 2A

### Primary Battery, Wound Pin-type Li/CF

The negative electrode was prepared by laminating 30 μm lithium foil onto both sides of 5 μm copper foil, for a total thickness of about 65 μm, leaving certain portions of the negative substrate free of lithium to facilitate connections and allow room for adhesive tape, as described above.

A positive active material slurry was prepared by mixing CFX, polytetrafluoroethylene (PTFE), carbon black, and carboxy methylcellulose (CMC) in a ratio of 80:4:10:6. The slurry was coated onto both sides of a 20-μm thick aluminum foil. The positive electrode was compressed to a final total thickness of about 108 μm. Portions of positive active material were scraped off to leave certain portions of the positive substrate uncoated, as described above.

The 21 mm×22 mm negative electrode and 20 mm×17 mm positive electrode were then spirally wound with a layer of 25 μm polypropylene separator between them, using the winding technique described above to form a jellyroll electrode assembly. Because lithium sticks to the case material during insertion, the outer layer of the electrode assembly was a layer of the separator material to facilitate introduction of the jellyroll into the case. Adhesive tape was applied to close the jellyroll in the manner described above. The jellyroll was inserted into a circular cylindrical stainless steel 0.1-mm thick case having a diameter of about 2.9 mm and a height of about 26 mm, for a total external volume of about 0.17 cm³. An electrolyte comprising LiPF₆ in a mixture of ethylene carbonate (EC) and diethyl carbonate (DEC) (1.2 M in 3:7 solvent) was delivered to the electrode assembly, but without using the C-shaped mandrel as a conduit in the above-described manner. The end of the battery case was closed, using the technique described above, hermetically sealing the case.

### EXAMPLE 2B

### Primary Battery, Wound Pin-type Li/CFₓ

A battery was prepared as in Example 2A, except that the positive active material slurry was prepared by mixing CFₓ, polytetrafluoroethylene (PTFE), carbon black, and carboxy methylcellulose (CMC) in a ratio of 81:3:10:6, the positive electrode was compressed to a final total thickness of about 140 μm, and the electrolyte comprised LiPF₆ in a mixture of propylene carbonate (PC) and dimethyl ether (DME) (1.2 M in 3:7 solvent).

The battery produced in Examples 2A and 2B were suitable for implanting in a human body, being hermetically sealed and very small. Although its volume and length were approximately double that of the rechargeable battery described in Example 1, due to its small diameter and circular cylindrical shape, this primary battery also can be used in a device inserted into the body using a syringe-like device having a needle. The shape of the battery produced herein is not limited to having a circular cross section, and may have a cross section that is oval, rectangular, or other shape. Preferably, the cross sectional area is less than about 7 mm². Using one or a combination of the various techniques described herein allows a spirally wound jellyroll-type electrode assembly to be fit into a very small battery case of a volume not seen in the prior art. The very small primary battery of this example is particularly suitable for applications for which it is important to have less of a voltage drop during pulsing, that do not require rechargeability.

### EXAMPLE 3

### Primary Battery, Coin Cell Li/SVO

The negative electrode was prepared by pressing 16-mm diameter, 250-μm thick lithium foil onto a case.

A positive active material slurry was prepared by mixing svo, polytetrafluoroethylene (PTFE), carbon black, and carboxy methylcellulose (CMC) in a ratio of 80:4:10:6. The slurry was coated onto 20-μm thick aluminum foil. 15 mm circles were die cut from the coated foil. The total positive electrode thickness was about 120 to 150 μm.

The anode and cathode were then separated with a 25 μm polypropylene separator between them to form an electrode assembly. The assembly was inserted into a 2032 coin cell case, which has a diameter of 20 mm and a thickness of 3.2 mm for a total external volume of about 1 cm³. An electrolyte comprising 1.2 M LiBF₄ in a mixture of propylene carbonate (PC) and dimethyl ether (DME) (3:7) was delivered to the electrode assembly. The coin cell was crimped. This coin cell is expected to perform well at the 3C rate.

From the foregoing, it should now be appreciated that an electric storage battery construction and method of manufacture have been described herein particularly suited for manufacturing very small, highly reliable batteries suitable for use in implantable medical devices. Although a particular preferred embodiment has been described herein and exemplary dimensions have been mentioned, it should be understood that many variations and modifications may occur to those skilled in the art falling within the spirit of the invention and the intended scope of the appended claims.

1. A positive electrode comprising:
a positive foil substrate; and
a slurry coated on both faces of said positive foil substrate, wherein the coating comprises an active material chosen from the group consisting of: Bi₂O₃, Bi₂Pb₂O₅, fluorinated carbon (CF)), CuCl₂, CuF₂, CuO, Cu₄O(PO₄)₂, CuS, FeS, FeS₂, MnO₂, MoO₃, Ni_{3S}₂, AgCl, Ag₂CrO₄, V₂O₅ and related compounds, silver vanadium oxide (SVO), or MO₆S₈; wherein
said active material comprises particles having an average diameter of greater than 1 μm to about 100 μm.

2. The positive electrode of claim 1 wherein said active material comprises particles having an average diameter of greater than 1 μm to about 50 μm.

3. The positive electrode of claim 1 wherein said active material comprises particles having an average diameter of about 2 μm to about 30 μm.

4. The positive electrode of claim 1 wherein said positive foil substrate comprises a material chosen from the group consisting of: aluminum, stainless steel, titanium, nickel, molybdenum, platinum iridium, and copper.

5. The positive electrode of claim 1 wherein said positive foil substrate comprises aluminum.

6. The positive electrode of claim 1 wherein said positive foil substrate has a thickness of about 1-50 μm.

7. The positive electrode of claim 1 wherein said positive foil substrate has a thickness of about 1-20 μm.

8. The positive electrode of claim 1 wherein said active material comprises CFₓ.

9. The positive electrode of claim 8 wherein said coating has a thickness of 10 μm to 250 μm.

10. The positive electrode of claim 1 wherein said active material comprises SVO.

11. The positive electrode of claim 10 wherein said coating has a thickness of 2 μm to 200 μm.

12. An electrode assembly comprising:
a negative electrode; and
a positive electrode according to claim 1.

13. The assembly of claim 12 wherein said negative electrode comprises a negative active material on a negative foil substrate.

14. The assembly of claim 13 wherein said negative foil substrate is chosen from the group consisting of copper, nickel, titanium, stainless steel, and aluminum.

15. The assembly of claim 13 wherein said negative foil substrate is chosen from the group consisting of copper, nickel, titanium, and stainless steel.

16. The assembly of claim 13 wherein said negative foil substrate comprises copper.

17. The assembly of claim 13 wherein said negative foil substrate has a thickness of about 1-50 μm.

18. The assembly of claim 13 wherein said negative foil substrate has a thickness of about 1-20 μm.

19. The assembly of claim 12 wherein said negative active material partially covers both faces of said negative foil substrate.

20. The assembly of claims 12 wherein said negative electrode comprises lithium.

21. The assembly of claims 12 wherein said positive and negative electrodes are wound to form a jellyroll.

22. The assembly of claim 21 further comprising an elongate pin around which said electrodes are wound.

23. The assembly of claim 22 wherein said elongate pin is electrically conductive.

24. The assembly of claim 22 wherein a portion of said pin forms a battery terminal.

25. The assembly of claim 22 wherein one of said electrodes is directly connected to said pin.

26. The assembly of claim 22 wherein one of said electrodes is connected to said pin by welding an interface material to said electrode and to said pin.

27. The assembly of claim 12 further comprising at least one separator separating said electrodes.

28. The assembly of claim 27 wherein an outer layer of said electrode assembly comprises said separator.

29. An electric storage battery including:
a case comprising a peripheral wall defining an interior volume;
an electrode assembly according to claims 12 mounted in said interior volume; and
an electrolyte.

30. The battery of claim 29 wherein said case peripheral wall defines an exterior width of less than 3 mm.

31. The battery of claim 29 wherein said case has an exterior volume of less than 1 cm³.

32. The battery of claim 29 wherein said case has an exterior volume of less than 0.5 cm³.

33. The battery of claim 29 wherein said case has an exterior volume of less than 0.1 cm³.

34. The battery of claim 29 wherein said case peripheral wall defines cross sectional area of less than about 7 mm².

35. The battery of claims 29 wherein said case is hermetically sealed.

36. A method for making an electrode comprising the acts of:
providing a foil substrate;
forming a slurry comprising an active material chosen from the group consisting of: Bi₂O₃, Bi₂Pb₂O₅, fluorinated carbon (CFₓ), CuCl₂, CuF₂, CuO, Cu₄O(PO₄)₂, CuS, FeS, FeS₂, MnO₂, MoO₃, Ni₃S₂, AgCl, Ag₂CrO₄, V₂O₅ and related compounds, silver vanadium oxide (SVO), or MO₆S₈; wherein said active material comprises particles having an average diameter of greater than 1 μm to about 100 μm; and coating the slurry onto both faces of the foil substrate.

37. The method of claim 36 wherein said active material comprises particles having an average diameter of greater than 1 μm to about 50 μm;.

38. The method of claim 36 wherein said active material comprises particles having an average diameter of about 2 μm to about 30 μm;.

39. The method of claim 36 wherein said act of providing a substrate comprises providing an aluminum foil substrate.

40. The method of claim 36 wherein said act of forming a slurry comprises mixing said active material, polytetrafluoroethylene, carbon black, and carboxy methylcellulose.

41. The method of claim 40 wherein said active material comprises SVO.

42. The method of claim 40 wherein said active material comprises CFₓ.

43. The method of claim 36, further comprising the act of compressing the coated foil substrate.

44. A method for making an electrode comprising the acts of:
providing a foil substrate;
forming a slurry comprising:
an active material chosen from the group consisting of: Bi₂O₃, Bi₂Pb₂O₅, fluorinated carbon (CFₓ), CuCl₂, CuF₂, CuO, Cu₄O(PO₄)₂, CuS, FeS, FeS₂, MnO₂, MoO₃, Ni₃S₂, AgCl, Ag₂CrO₄, V₂O₅ and related compounds, silver vanadium oxide (SVO), or MO₆S₈; wherein said active material comprises particles having an average diameter of greater than 1 μm to about 100 μm,
polytetrafluoroethylene,
carbon black, and
carboxy methylcellulose; and
coating said slurry onto the foil substrate.

45. The method of claim 36 wherein said act of providing a foil substrate comprises providing an aluminum foil substrate.

46. The method of claim 36 wherein said act of coating the slurry onto the foil substrate comprises coating the slurry onto both faces of the foil substrate.

47. The method of claim 36, further comprising the act of compressing the coated foil substrate.

48. A method for making an electrode comprising the acts of:
providing a negative foil substrate; and
laminating lithium foil onto both faces of the negative foil substrate, leaving a portion of the negative foil substrate free of lithium, wherein said lithium foil has a thickness of between 1.5μ and 130 μm.

49. The method of claim 48 wherein said act of providing a negative substrate comprises providing a negative foil substrate chosen from the group consisting of copper, nickel, titanium, stainless steel, and aluminum.

50. The method of claim 48 wherein said act of providing a negative substrate comprises providing a negative foil substrate chosen from the group consisting of copper, nickel, titanium, and stainless steel.

51. The method of claim 48 wherein said act of providing a negative substrate comprises providing a copper foil substrate.

52. The method of claim 48 wherein said act of providing a negative substrate comprises providing a negative substrate having a thickness of about 1 μm to about 50 μm.

53. The method of claim 48 wherein said act of providing a negative substrate comprises providing a negative substrate having a thickness of about 1 μm to about 20 μm.

54. A method for making an electrode assembly comprising the acts of:
forming a negative electrode comprising the acts of:
providing a negative foil substrate;
providing lithium foil having a thickness of 1.5 μm to 50 μm; and
laminating the lithium foil onto both faces of the negative foil substrate, leaving a portion of the negative foil substrate free of lithium;
forming a positive electrode comprising the acts of:
providing a positive foil substrate; and
coating a slurry on both faces of the positive foil substrate, wherein the coating comprises SVO;
drying the coating; and
compressing the positive electrode such that the coating has a thickness of between about 2 μm and about 200 μm; and
winding together the negative and positive electrodes to form a spiral roll.

55. A method for making an electrode assembly comprising the acts of:
forming a negative electrode comprising the acts of:
providing a negative foil substrate;
providing lithium foil having a thickness of 4 μm to 130 μm; and
laminating lithium foil onto both faces of the negative foil substrate, leaving a portion of the negative foil substrate free of lithium;
providing a positive electrode comprising the acts of:
providing a positive foil substrate;
coating a slurry on both faces of the positive foil substrate, wherein the coating comprises CFₓ;
drying the coating; and
compressing the positive electrode such that the coating has a thickness of between about 10 μm and about 250 μm; and
winding together the negative and positive electrodes to form a spiral roll.

56. A hermetically sealable electric storage battery comprising:
a case having an open end;
an end cap;
a first electrically conductive terminal extending through and electrically insulated from said end cap;
an electrode assembly disposed within said case and comprising first and second opposite polarity electrodes separated by separators wherein said first electrode is electrically coupled to said first terminal;
a flexible conductive tab electrically coupled to said second electrode proximate a first location at said case open end;
said tab electrically connected to said end cap at a second location whereby said end cap has a first bias position tending to keep said case open end open and a second bias position tending to maintain closure of said case open end.

57. The battery of claim 56 wherein said first bias position orients said end cap approximately perpendicular to said open end.

58. The battery of claim 56 wherein said end cap is electrically and mechanically coupled to said tab flat against an inner face of said end cap.

59. The battery of claim 56 wherein said end cap is welded to said tab flat against an inner face of said end cap.

60. The battery of claim 56 wherein:
said end cap has a width W;
the distance from said second location to said case open end is a length L; and
L≦W.

61. The battery of claim 60 wherein said second location is above the center of said end cap in said first bias position.

62. The battery of claim 60 wherein said end cap overlaps the case by approximately W/4 in said first bias position.

63. An electric storage battery including:
a case comprising a peripheral wall defining an interior volume and a cross sectional area less than 7 mm²; and
an electrode assembly mounted in said interior volume, said electrode assembly including first and second opposite polarity electrode strips wound together to form a spiral roll.

64. The electric storage battery of claim 63 wherein said case is hermetically sealed.

65. The electric storage battery of claim 29 wherein said battery is rechargeable.

66. The electric storage battery of claim 29 wherein said battery is a primary battery.

67. The electric storage battery of claim 29 wherein said battery is a lithium or lithium ion battery.

68. The electric storage battery of claim 29 wherein said electrode assembly further includes:
an electrically conductive elongate pin; and
wherein each electrode strip has inner and outer ends, wherein said first electrode strip is electrically coupled to said pin at said inner end.

69. A method of joining an electrode substrate to a pin comprising the acts of:
providing an electrode substrate comprising a first material;
providing a pin comprising a second material that is not easily welded to the first material;
providing an interface material;
welding the interface material to the substrate; and
welding the interface material to the pin.

70. The method of claim 69 wherein said interface material comprises nickel, said first material comprises aluminum, and said second material comprises titanium.

71. The method of claim 69 wherein said interface material is welded along a length of the substrate.

72. The method of claim 69 wherein said acts of welding the interface material to the substrate and to the pin are performed using resistance welding.

73. The method of claim 69 wherein said acts of welding the interface material to the substrate and to the pin are performed using ultrasonic welding.

74. The electric storage battery of claim 56 wherein said battery is rechargeable.

75. The electric storage battery of claim 56 wherein said battery is a primary battery.

76. The electric storage battery of claim 56 wherein said battery is a lithium or lithium ion battery.

77. The electric storage battery of claim 56 wherein said electrode assembly further includes:
an electrically conductive elongate pin; and
wherein each electrode strip has inner and outer ends, wherein said first electrode strip is electrically coupled to said pin at said inner end.

78. The electric storage battery of claim 63 wherein said battery is rechargeable.

79. The electric storage battery of claim 63 wherein said battery is a primary battery.

80. The electric storage battery of claim 63 wherein said battery is a lithium or lithium ion battery.

81. The electric storage battery of claim 63 wherein said electrode assembly further includes:
an electrically conductive elongate pin; and
wherein each electrode strip has inner and outer ends, wherein said first electrode strip is electrically coupled to said pin at said inner end.
